(19) United States
(12) Patent Application Publication
(10) Pub. No.: US 2025/0291078 A1
(43) Pub. Date: Sep. 18, 2025

(54) METHODS AND APPARATUS FOR STOCHASTIC SEISMIC DATA INVERSION BY ENFORCING THE LOW FREQUENCY MODEL

(71) Applicant: BP Corporation North America Inc., Houston, TX (US)

(72) Inventor: Jingfeng Zhang, Houston, TX (US)

(73) Assignee: BP Corporation North America Inc., Houston, TX (US)

(21) Appl. No.: 19/071,062

(22) Filed: Mar. 5, 2025

Related U.S. Application Data
(60) Provisional application No. 63/564,114, filed on Mar. 12, 2024.

(51) Int. Cl. G01V 1/30

(52) U.S. Cl. CPC G01V 1/30; G01V 2210/66

(57) ABSTRACT

A method for stochastic seismic data inversion by enforcing the low frequency model includes generating at least one earth model based at least in part on input seismic data of a subsurface region and an input low frequency model of the subsurface region, generating synthetic seismic data based on the at least one earth model, iteratively updating, using the generated synthetic seismic data, a value of the at least one earth model to generate at least one updated earth model, and generating at least one final earth model from the updated earth model matching the input seismic data, wherein a low pass filtered version of the at least one final earth model matches the input low frequency model.

### CROSS REFERENCE TO RELATED APPLICATIONS

This application claims benefit of U.S. provisional patent application Ser. No. 63/564,114 filed Mar. 12, 2024, and entitled “Methods and Apparatus for Stochastic Seismic Data Inversion by Enforcing the Low Frequency Model,” which is hereby incorporated herein by reference in its entirety for all purposes.

### STATEMENT REGARDING FEDERALLY SPONSORED RESEARCH OR DEVELOPMENT

Not applicable.

### BACKGROUND

A seismic survey includes generating an image or map of a subsurface region of the Earth by sending sound energy down into the ground and recording the reflected sound energy that returns from the geological layers within the subsurface region. During a seismic survey, an energy source is placed at various locations on or above the surface region of the Earth, which may include hydrocarbon deposits. Each time the source is activated, the source generates a seismic (e.g., sound wave) signal that travels downward through the Earth, is reflected, and, upon its return, is recorded using one or more receivers disposed on or above the subsurface region of the Earth. The seismic data recorded by the receivers may then be used to create an image or profile of the corresponding subsurface region.

### SUMMARY

Methods and apparatus for stochastic seismic data inversion by enforcing the low frequency model are disclosed herein. In an embodiment, a method for stochastic seismic data inversion by enforcing the low frequency model comprises generating at least one earth model based at least in part on input seismic data of a subsurface region and an input low frequency model of the subsurface region; generating synthetic seismic data based on the at least one earth model; iteratively updating, using the generated synthetic seismic data, a value of the at least one earth model to generate at least one updated earth model, wherein iteratively updating the at least one earth model comprises applying a low pass filter to the at least one earth model to generate a low pass filtered version of the at least one earth model, and comparing the low pass filtered version of the at least one earth model to the input low frequency model such that a low pass filtered version of the updated earth model is iteratively shifted towards the input low frequency model; and generating at least one final earth model from the updated earth model matching the input seismic data, wherein a low pass filtered version of the at least one final earth model matches the input low frequency model. In some embodiments, generating the at least one earth model comprises generating a value for the at least one earth model based on at least one of geological, petrophysical, and seismic data. In certain embodiments, the method further comprises forward modeling the at least one earth model to generate the synthetic seismic data. In other embodiments, forward modeling the at least one earth model comprises solving Zoeppritz equation using the at least one earth model to generate the synthetic seismic data. In some embodiments, the method comprises utilizing a probabilistic algorithm during iteratively updating the value of the at least one earth model utilizing the synthetic seismic data, observed seismic data, and the input low frequency model. In certain embodiments, forward modeling the at least one earth model comprises forming a gradient score as the value of the at least one earth model as part of the probabilistic algorithm and the input low frequency model. In other embodiments, the gradient score comprises both a probabilistic algorithm component and a separate low frequency model component. In some embodiments, the method further comprises determining the low frequency model component of the gradient score based on the low pass filtered version of the at least one earth model. In certain embodiments, a frequency range of the low pass filter matches a frequency range of the input low frequency model. In other embodiments, iteratively updating the value of the at least one earth model comprises matching the low frequency filtered version of the at least one earth model to the input low frequency model. In some embodiments, the at least one earth model corresponds to at least one subsurface elastic parameter. In certain embodiments, the method further comprises producing the at least one final earth model as a target distribution.

In an embodiment, a system for stochastic seismic data inversion by enforcing the low frequency model comprises one or more processors; and a storage device coupled to the one or more processors, the storage device configured to store instructions that, when executed by the one or more processors, configure the one or more processors to generate at least one earth model based at least in part on input seismic data of a subsurface region and an input low frequency model of the subsurface region; generate synthetic seismic data based on the at least one earth model; iteratively update, using the generated synthetic seismic data, a value of the at least one earth model to generate at least one updated earth model, wherein iteratively updating the at least one earth model comprises applying a low pass filter to the at least one earth model to generate a low pass filtered version of the at least one earth model, and comparing the low pass filtered version of the at least one earth model to the input low frequency model such that a low pass filtered version of the updated earth model is iteratively shifted towards the input low frequency model; and generate at least one final earth model from the updated earth model matching the input seismic data, wherein a low pass filtered version of the at least one final earth model matches the input low frequency model. In some embodiments, the instructions, when executed by the one or more processors, configure the one or more processors to generate a value for the at least one earth model based on at least one of geological, petrophysical, and seismic data. In certain embodiments, the instructions, when executed by the one or more processors, configure the one or more processors to forward model the at least one earth model to generate the synthetic seismic data. In other embodiments, the instructions, when executed by the one or more processors, configure the one or more processors to solve Zoeppritz equation using the at least one earth model to generate the synthetic seismic data. In some embodiments, the instructions, when executed by the one or more processors, configure the one or more processors to utilize a probabilistic algorithm during iteratively updating the value of the at least one earth model utilizing the synthetic seismic data, observed seismic data, and the input low frequency model. In certain embodiments, the instructions, when executed by the one or more processors, configure the one or more processors to form a gradient score as the value of the at least one earth model as part of the probabilistic algorithm and the input low frequency model. In other embodiments, the gradient score comprises both a probabilistic algorithm component and a separate low frequency model component. In some embodiments, the instructions, when executed by the one or more processors, configure the one or more processors to determine the low frequency model component of the gradient score based on the low pass filtered version of the at least one earth model.

### BRIEF DESCRIPTION OF THE DRAWINGS

Various aspects of this disclosure may be better understood upon reading the following detailed description and upon reference to the drawings in which:

FIG. 1 illustrates a flow chart of various processes that may be performed based on analysis of seismic data acquired via a seismic survey system;

FIG. 2 is an embodiment of a system for performing a marine seismic survey in accordance with principles described herein;

FIG. 3 is an embodiment of a system for performing a land-based seismic survey in accordance with principles described herein;

FIG. 4 is a block diagram of an embodiment of a computer system in accordance with principles described herein;

FIGS. 5-12 are graphical representations illustrating examples of different subsurface models matching observed seismic data but generating different elastic parameters in accordance with principles disclosed herein;

FIG. 13 is a flow diagram illustrating operation of a stochastic seismic inversion in accordance with principles disclosed herein;

FIG. 14 is a graphical representation illustrating a comparison of the mean posterior distribution of different subsurface model data with the mean posterior distribution of the target subsurface model data in accordance with principles disclosed herein;

FIG. 15 is a graphical representation illustrating a comparison of a one particle posterior distribution of different subsurface model data with a one particle posterior distribution of the target subsurface model data in accordance with principles disclosed herein;

FIG. 16 is a graphical representation illustrating a comparison of different subsurface model data with target subsurface model data in accordance with principles disclosed herein; and

FIG. 17 is a flowchart illustrating an embodiment of a method for stochastic seismic data inversion in accordance with principles disclosed herein.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

There are various seismic inversion methods employed in geophysics including amplitude variation with offset (AVO) inversion (or amplitude versus offset inversion) and Full-waveform inversion (FWI). AVO is particularly valuable in hydrocarbon exploration for characterizing reservoirs and identifying fluid content. In some embodiments, methods that may be used to improve interpretation of seismic data via the use of AVO inversion are discussed herein. More particularly, the present systems and methods relate to a probabilistic approach to inversion (e.g., AVO inversion) which uses low frequency modeling enforced stochastic seismic inversion to allow for improved accuracy of the determined subsurface structure and properties of a formation (e.g., a formation's fluid content, porosity, density, etc.), and reliability of subsurface models, etc.

In some embodiments, probabilistic inversion is performed on seismic data for the purpose of reservoir characterization. For example, probabilistic inversion may be used to estimate subsurface elastic parameters (e.g., p-wave and s-wave velocities, density, etc.) from processed seismic data (e.g., angle gathers, stacks, etc.). The probabilistic volumes may also be used to derive seismic volumes, such as band-limited reflectivity and elastic impedance, which are less noisy than conventionally processed data. The probabilistic volumes can additionally be used in computing elastic moduli and inferring other petro-physical properties, such as fluid and lithology types. The resulting probabilistic volumes (which may be 3D volumes) which incorporate uncertainties and variations inherent in the subsurface may use the input low frequency subsurface model as an additional constraint to generate and allow for the selection of more accurate and reliable subsurface models of the resulting probabilistic volumes. For example, the probabilistic volumes may be used to improve direct geological interpretation by utilizing the low frequency input model and as an additional constraint in generating the posterior distribution defining the resulting probabilistic volumes. In some embodiments, the input low frequency model may be derived from velocity model building techniques such as FWI, Horizon-guided low frequency extrapolation, and geostatistical extrapolation (e.g., Kriging). The frequency range is determined by the input low frequency model and may include frequencies for example, below 1 Hertz (Hz), greater than 1 Hz but less than 10 Hz, greater than 10 Hz but less than 20 Hz, etc. depending on the seismic source, geological structure, and the nature of the data received, provided that the low pass filter is the same frequency range as the input low frequency model. In this manner, after low pass filtering, the final inverted elastic properties of the subsurface region such as p-wave, s-wave and density are required to match or agree with the input low frequency model. Thus, the specific methods described herein lead to generation of probabilistic volumes that have improved accuracy without corresponding alterations to the complexity of the hardware of the computing system generating the probabilistic volumes.

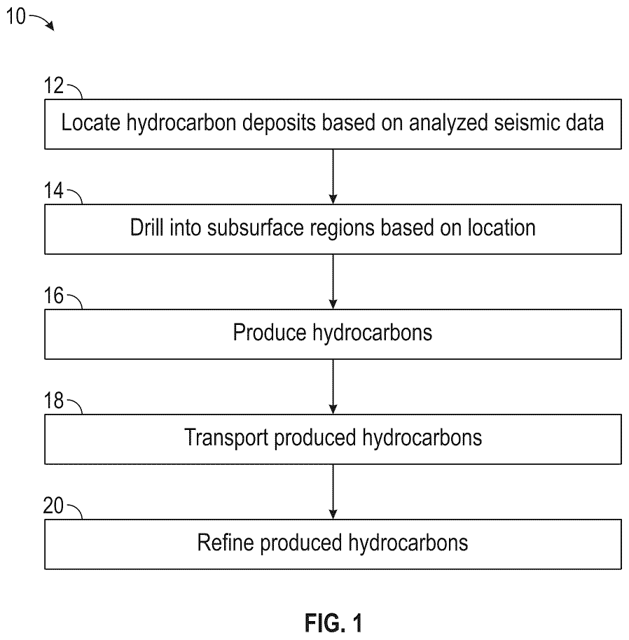

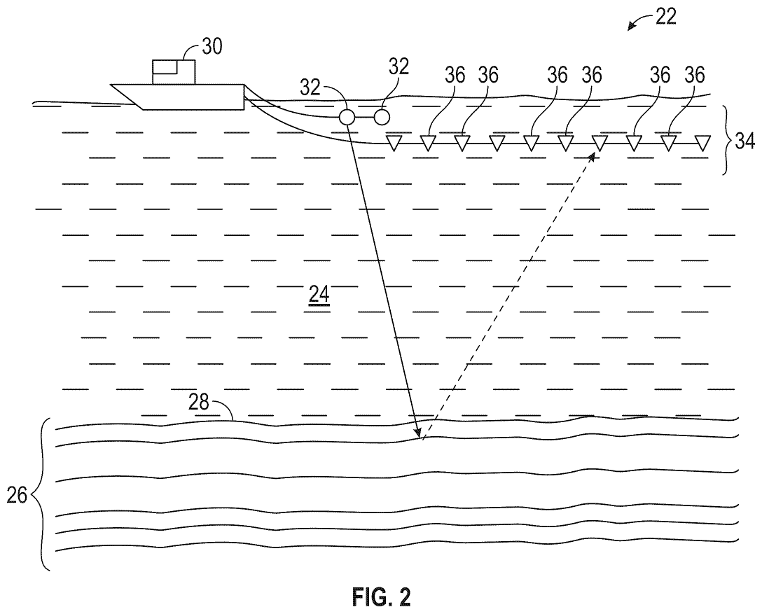

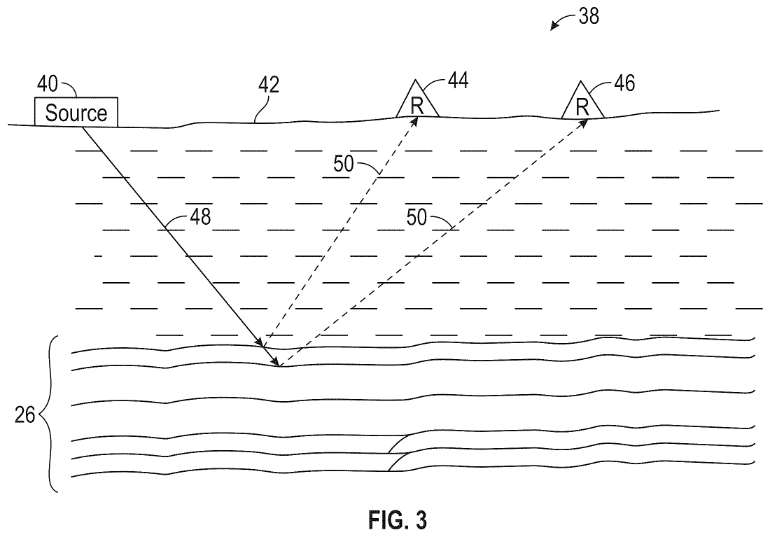

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the seismic streamer 34 having a seismic receiver 36 (e.g., hydrophones) that may acquire seismic waveforms that represent the energy output by the seismic source(s) 32 subsequent to being reflected off of various geological formations (e.g., salt domes, faults, folds, etc.) within the subsurface region 26. Additionally, although the description of the marine survey system 22 is described with one seismic source 32 (represented in FIG. 2 as an air gun array) and one seismic receiver 36 (represented in FIG. 2 as a set of hydrophones), it should be noted that the marine survey system 22 may include multiple seismic sources 32 and multiple seismic receivers 36. In the same manner, although the above descriptions of the marine survey system 22 is described with one seismic streamer 34, it should be noted that the marine survey system 22 may include multiple streamers similar to seismic streamer 34. In addition, additional vessels 30 may include additional seismic source(s) 32, seismic streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based seismic receiver 44. In some embodiments, the land survey system 38 may include multiple land-based seismic sources 40 and one or more land-based seismic receivers 44 and 46. Indeed, for discussion purposes, the land survey system 38 includes a land-based seismic source 40 and two land-based seismic receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations and acquired or recorded by one or more land-based receivers (e.g., 44 and 46).

In some embodiments, the land-based seismic receivers 44 and 46 may be dispersed across the surface 42 of the Earth to form a grid-like pattern. As such, each land-based seismic receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A first seismic receiver 44 may receive the reflection of the seismic waveform 48 off of one geological formation and a second seismic receiver 46 may receive the reflection of the seismic waveform 48 off of a different geological formation. As such, the first seismic receiver 44 may receive a reflected seismic waveform 50 and the second seismic receiver 46 may receive a reflected seismic waveform 52.

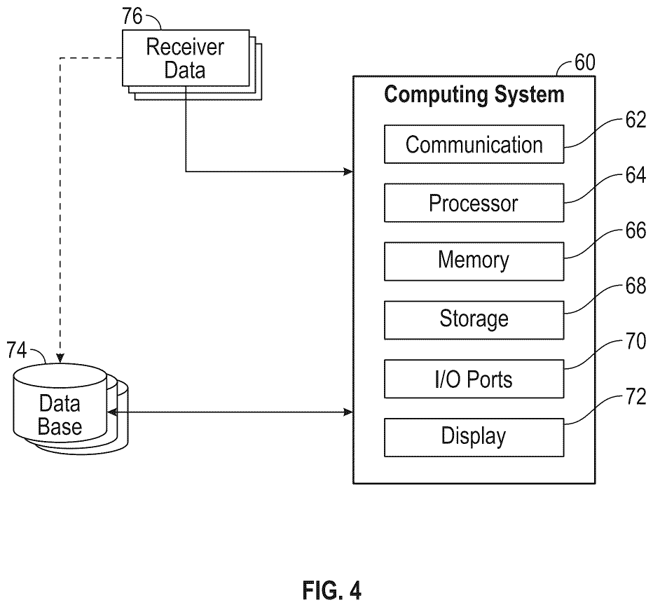

Regardless of how the seismic data is acquired, a computing system (e.g., for use in conjunction with block 12 of FIG. 1) may analyze the seismic waveforms acquired by the seismic receivers 36, 44, 46 to determine seismic information regarding the geological structure, the location and property of hydrocarbon deposits, and the like within the subsurface region 26. FIG. 4 is a block diagram of an example of such a computer or computing system 60 that may perform various data analysis operations to analyze the seismic data acquired by the seismic receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between the seismic receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the seismic receivers 36, 44, 46, and the like. Further, it should be noted that the listed components are provided as example components and the embodiments described herein are not to be limited to the components described with reference to FIG. 4.

In some embodiments, the computing system 60 may generate a two-dimensional representation or a three-dimensional representation of the subsurface region 26 based on the seismic data received via the receivers mentioned above. Additionally, seismic data associated with multiple source/receiver combinations may be combined to create a near continuous profile of the subsurface region 26 that can extend for some distance. In a two-dimensional (2-D) seismic survey, the receiver locations may be placed along a single line, whereas in a three-dimensional (3-D) survey the receiver locations may be distributed across the surface in a grid pattern. As such, a 2-D seismic survey may provide a cross sectional picture (vertical slice) of the Earth layers as they exist directly beneath the recording locations. A 3-D seismic survey, on the other hand, may create a data “cube” or volume that may correspond to a 3-D picture of the subsurface region 26.

In addition, a 4-D (or time-lapse) seismic survey may include seismic data acquired during a 3-D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

Inversion (e.g., AVO inversion, FWI inversion) is one of many techniques used in seismic analysis. As used herein, the terms “inversion” and “seismic inversion” refer to methods for process that use observed seismic data to estimate properties of an Earthen subsurface region. Generally, inversion involves solving an inverse problem, where the goal is to determine the distribution of physical properties (e.g., acoustic impedance, velocity, density) in the Earth's subsurface that best explains the observed seismic data.

In some applications, for better accuracy, inversion may be performed using a probabilistic approach whereby for example, the outcome is represented by a distribution of possible volumes (Bayesian approach) or a diverse set of subsurface models which capture the variability and uncertainty in the generated output (Stochastic approach). Particularly, current approaches to elastic stochastic seismic inversion use input or prior models that include low frequency models (LFMs) (e.g., p-wave, s-wave and density) or samples around those LFMs as a starting point or input in an iterative process whereby those initial models are updated (e.g., producing updated subsurface models) by matching observed seismic data without honoring or matching the LFM. Therefore, after low pass filtering, the final inverted elastic properties of the subsurface region such as p-wave, s-wave and density generally are not required to match or agree with the input low frequency model. However, failing to require agreement between the updated subsurface model of a given iteration and the input LFM results in a posterior distribution of subsurface models including a substantially larger pool of subsurface models which agree with the same observed seismic data but yet are not geologically correct (e.g., they do not accurately model the subsurface region). To state in other words, the observed seismic data by itself is an inadequate constraint and thus failing to leverage the input low velocity model as a constraint results in a substantial increase in the number of subsurface models of the posterior distribution that are not geologically correct. This increase in the number of geologically incorrect subsurface models of the posterior distribution thereby reduces the accuracy of the posterior distribution in terms of accurately describing the subsurface region. Thus, an additional constraint may be useful to limit the null space (i.e., remove models that match the observe seismic data but do not honor the input low frequency model), obtain better inversion results and thereby improve accuracy of the determined properties of the subsurface structures.

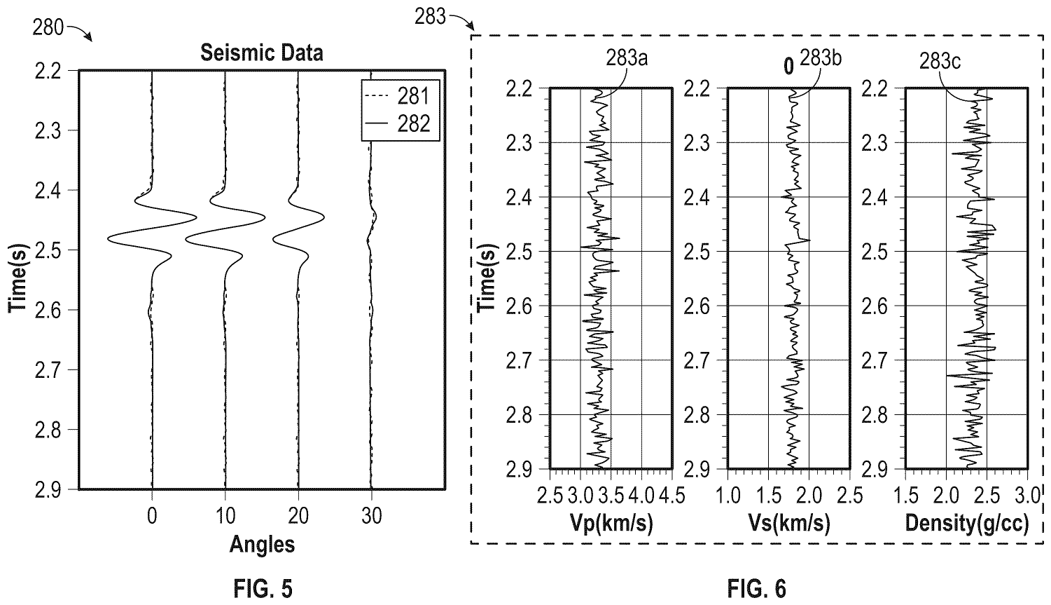

To further illustrate this issue, and referring to FIGS. 5-12, graphical representations illustrating examples of different subsurface models matching the same observed seismic data but generating different elastic parameters are shown. Particularly, FIGS. 5, 7, 9, and 11 illustrate graphs of an overlay of a plot of observed seismic data with a plot of synthetic or modeled seismic data produced from different subsurface models constrained to match the observed seismic data, while FIGS. 6, 8, 10, and 12 illustrate the parameters of these subsurface models. In some embodiments, the observed seismic data may be obtained using marine survey system 22 shown in FIG. 2 or land survey system 38 shown in FIG. 3. In this example, the subsurface models of FIGS. 6, 8, 10, and 12 may be obtained using a seismic inversion method where the observed seismic data (and not the input low frequency model) is used as a constraint.

FIG. 5 particularly illustrates a graph 280 plotting observed seismic data 282 and synthetic seismic data 281 generated by a first subsurface model as a function of time (y-axis) and offset angle (x-axis). In addition, FIG. 6 illustrates a graph 283 of elastic parameters (p-wave velocity (Vp) 283a, s-wave velocity (Vs) 283b, and density 283c) of the first subsurface model. Particularly, graph 283 plots the elastic parameters of the first subsurface model as a function of time (y-axis) and speed in kilometers/second (km/s) (for parameters Vp 283a and Vs 283b) and density in grams per cubic centimeter (g/cc) (for density 283c) along the x-axis. Synthetic seismic data 281 of FIG. 5 is generated using the first subsurface model illustrated in FIG. 6 where the first subsurface model is constrained to match observed seismic data 282.

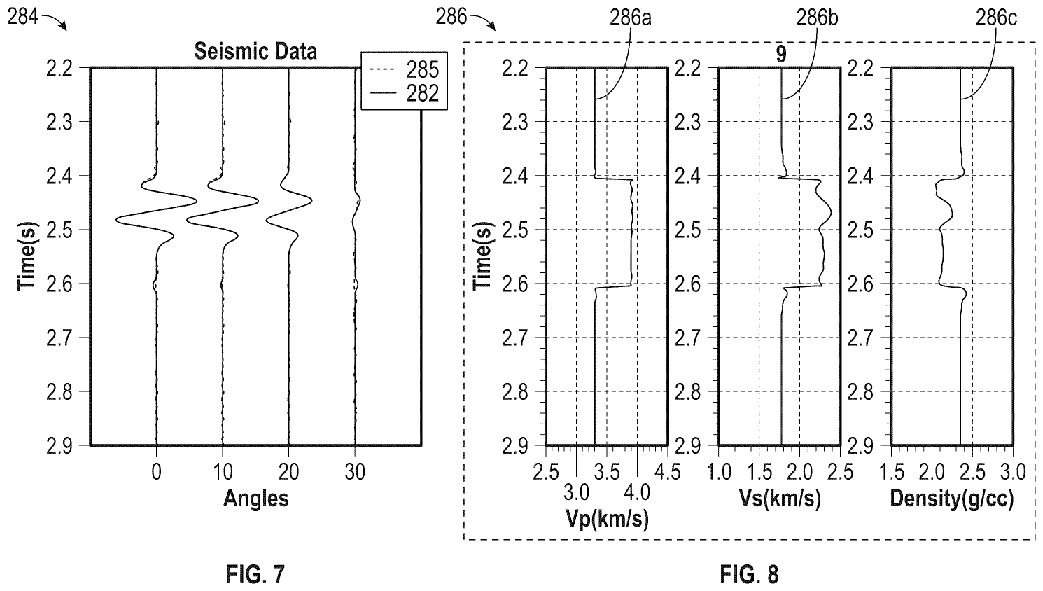

FIG. 7 particularly illustrates a graph 284 plotting observed seismic data 282 and synthetic seismic data 285 generated by a second subsurface model as a function of time on the y-axis thereof and offset angle on the x-axis thereof. Here, the elastic parameters Vp 286a, Vs 286b and density 286c of the second subsurface model are plotted in a graph 286 of FIG. 8. Particularly, FIG. 8 show elastic parameters 286a, 286b, and 286c of the second subsurface model having time plotted on the y-axis thereof against velocity in km/s for Vp 286a and Vs 286b, and density in g/cc for density 286c on the x-axis thereof. Synthetic seismic data 285 of FIG. 7 is generated using the second subsurface model of FIG. 8 which has negligible difference from the observed seismic data 282. As can be observed in FIGS. 6 and 8, the elastic parameters 283a, 283b, and 283c of the first subsurface model are substantially different from the elastic parameters 286a, 286b, and 286c of the second subsurface model even though both the first and second subsurface model have synthetics that match the same observed seismic data 282.

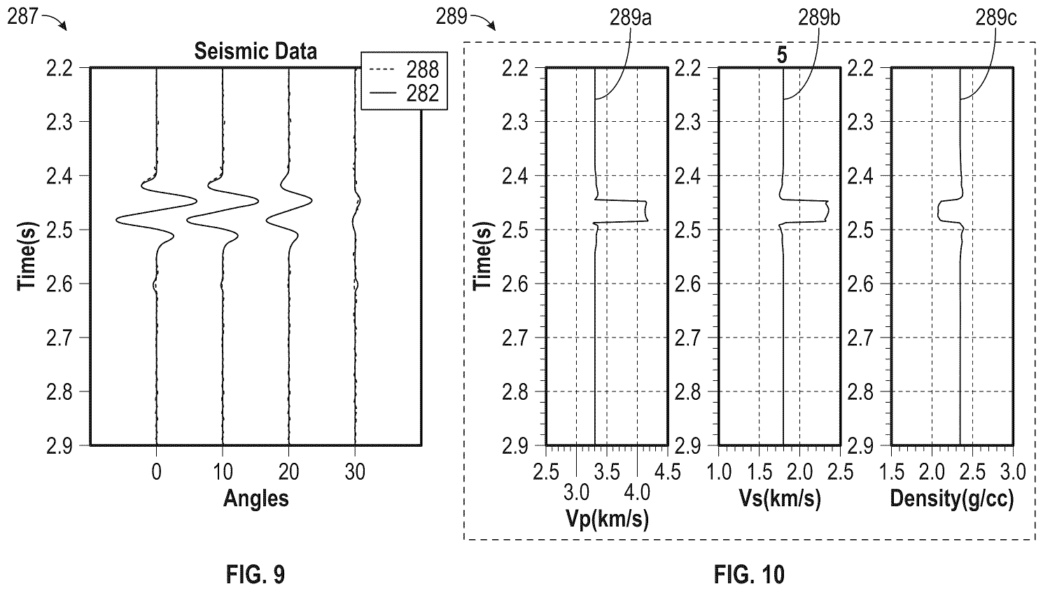

FIG. 9 particularly illustrates a graph 287 plotting observed seismic data 282 and synthetic seismic data 288 generated by a third subsurface model as a function of time on the y-axis thereof and offset angles on the x-axis thereof. Here, elastic parameters Vp 289a, Vs 289b and density 289c of the third subsurface model are plotted in graph 289 of FIG. 10. Particularly, FIG. 10 show elastic parameters 289a, 289b, and 289c of the third subsurface model having time plotted on the y-axis thereof against velocity in km/s for Vp 289a Vs 289b, and density in g/cc for density 289c on the x-axis thereof. Synthetic seismic data 288 of FIG. 9 is generated using the third subsurface model of FIG. 10 which has synthetics that match the same observed seismic data 282. However, the elastic parameters 289a, 289b, and 289c of the third subsurface model are substantially different from the elastic parameters of the first and second subsurface models.

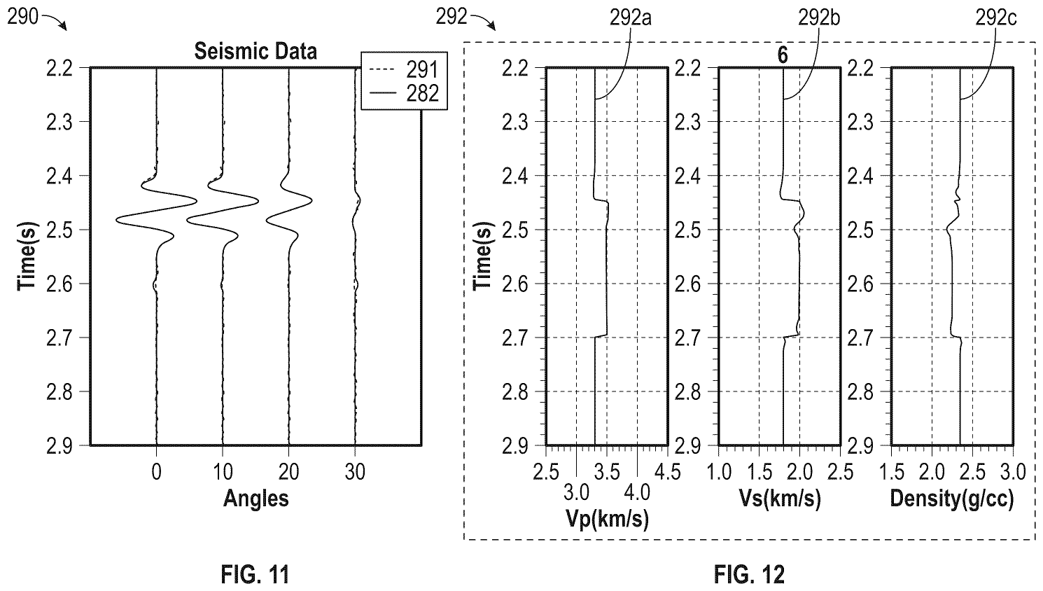

FIG. 11 particularly illustrates a graph 290 plotting observed seismic data 282 and synthetic seismic data 291 generated by a fourth subsurface model as a function of time on the y-axis thereof and offset angle on the x-axis thereof. Here, elastic parameters Vp 292a, Vs 292b, and density 292c of the fourth subsurface model are plotted respectively in graph 292 of FIG. 12. Particularly, FIG. 12 show elastic parameters 292a, 292b, and 292c of the fourth subsurface model having time plotted on the y-axis thereof against velocity in km/s for Vp 292a Vs 292b, and density in g/cc for density 292c on the x-axis thereof. Synthetic seismic data 291 of FIG. 11 is generated using the fourth subsurface model of FIG. 12 which has synthetics matching the same observed seismic data 282. However, again, the elastic parameters 292a, 292b, and 292c of the fourth subsurface model are again substantially different from the elastic parameters of the first, second, and third subsurface models described above.

With the foregoing in mind, when using the observed seismic data as the only constraint, the inversion algorithm will have a larger pool of possible models to match the observed seismic data and each matched model may generate a different set of elastic parameters as indicated in FIGS. 6, 8, 10, and 12. Thus, the observed seismic data is only a weak constraint insufficient for eliminating many geologically incorrect subsurface models from the resulting posterior distribution, resulting in a less accurate posterior distribution.

Accordingly, in an embodiment, inversion (e.g., AVO inversion) may be performed using a probabilistic (e.g., stochastic) approach set up to match both the observed seismic data, and the low frequency model which carries information about large scale structures and the overall geometry in the subsurface. Using the low frequency model as a starting point and an additional constraint may offer more accurate and reliable inversion outcome resulting in a more accurate posterior distribution (e.g., weeding out more geologically incorrect subsurface models). In some embodiments, the probabilistic approach may be performed as a low frequency modeling enforced stochastic optimization process using for example, Stein Variational Gradient Descent (SVGD) whereby each iterative update checks the low pass filtered version of the broader spectrum model to ensure that it matches the initial low frequency model. In certain embodiments, other inversion algorithms other than SVGD (e.g., FWI, waveform tomography, Bayesian inversion, etc.) may be used.

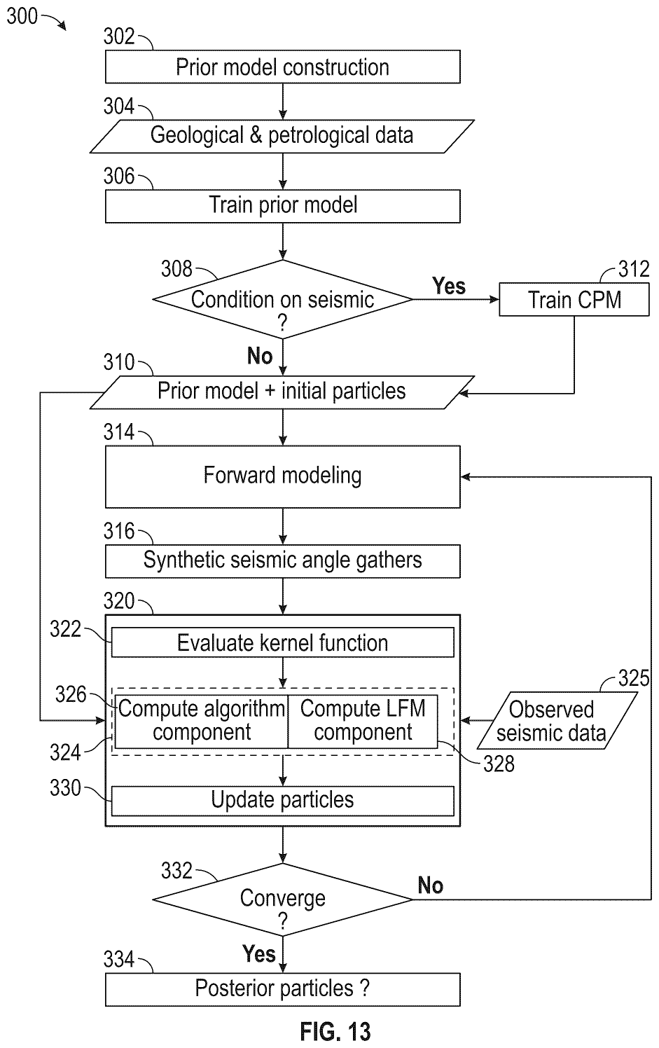

FIG. 13 illustrates one example of a method to carry out low frequency model enforced stochastic inversion to estimate subsurface elastic parameters and their associated uncertainties. This process may be performed using the computing system 60 to analyze acquired seismic data (e.g., performed as code stored on a tangible and non-transitory machine readable medium, such as the memory 66 and/or the storage 68, that when in operation causes the processor 64 to perform one or more of the steps of the method 300). Generally, method 300 begins at block 302, which represents prior model construction including low frequency model (LFM) construction. In some embodiments, the prior model construction is based on initial input data. The LFM model may be a statistical model (e.g., encoded or presented in a mathematical function, representation, or parameterization, or derived from velocity model building, or through horizon guided smoothing). Block 302, as illustrated, includes various sub-processes, which are illustrated in method 300 as block 304, block 306, block 308, block 310, and block 312. At block 304 geological and petrophysical data is received by computing system 60. Examples of this data may be well logs, geological descriptions (rock types, etc.), and geophysical data. Particularly at block 304, the seismic data and the prior model including the LFM constructed at block 302 are received by computing system 60. As previously mentioned, the LFM may be built from any seismic imaging technique such as tomography or Full-Waveform inversion (FWI). At block 306, the computing system 60 operates to train the prior model.

Probability distributions utilized in conjunction with the technique illustrated in FIG. 13 can be represented by one or more earth models, parameterized in terms of P-wave speed (Vp), S-wave speed (Vs), and density (e.g., density characteristics of a rock formation or type). The probability distributions may be represented by other physical representations of the subsurface which may collectively be referred to as particles. In some embodiments, the training of the prior model at block 306 includes the use of Gaussian, uniform, and/or Gaussian mixture models to generate statistical models as the prior model (or portions thereof).

In some embodiments, block 308 determines whether initial particles are to be conditioned on seismic data and, if so, block 312 can be undertaken. Block 312 involves training a conditioned prior model (CPM). That is, in some embodiments, there is an additional option to condition the prior model on input seismic data on a sample-by-sample basis. This CPM at block 312 may be used to generate at least one initial particle (e.g., different initial particles) which are distributed according to an approximation of the target posterior distribution, thus improving convergence of the optimization as, for example, an enhanced Gaussian mixture model. Block 312 may be undertaken based upon whether conditioning of the seismic data is selected at block 308 which, as described above, may be selected based on the desired results and/or efficiency, complexity, time, etc. to be undertaken with respect to block 302. In other embodiments, blocks 308 and 312 may be removed from block 302. In some embodiments, method 300 may not include generating a CPM and thus may exclude blocks 308 and 312.

The output of block 302 may be the prior model and at least one initial particle as illustrated at block 310, which may (in some embodiments) occur directly subsequent to block 306 or subsequent to block 308 and block 312. The initial particles of block 310 may be derived, e.g., sampled from the LFM, when block 310 directly follows block 306. Alternatively, the initial particles may be generated subsequent to blocks 308 and 312 in which the prior model is conditioned with seismic data to arrive at the CPM. The CPM of block 312 may be sampled to generate initial particles for block 310.

Method 300 additionally includes block 314, which represents forward modeling, and block 320, which represents the computing system 60 running an efficient particle-based probabilistic algorithm known as Stein Variational Gradient Descent (SVGD). It should be noted that SVGD is used as the inversion engine described herein for illustrative purposes only. Other algorithms other than SVGD may also be used. To perform SVGD, probability distributions are represented by sets of particles instead of probability density functions. These particles are separate realizations of the 1D elastic earth models consisting of P-wave velocity, S-wave velocity and density profiles. In SVGD, various kernels (e.g., scalar-valued kernels or more general matrix-valued kernels) may be tested for best performance.

Block 314 includes forward modeling that is performed to generate synthetic seismograms for at least one particle. That is, block 314 includes receipt of particles from block 310. The computing system 60, in conjunction with block 314, operates to generate synthetic seismic data by, for example, solving the full Zoeppritz equation to obtain the desired synthetic seismic data as an output at block 316. Thus, block 314 operates to generate synthetic seismic data based upon the initial particles described above and received from block 310, i.e., to generate synthetic seismic data based upon different combinations of Vp, Vs, and density. In this manner, synthetic seismic angle gathers are generated at block 316 based on the block undertaken at block 314. These gathers are provided to the block 320. Additionally, observed seismic data and the initial LFM are provided to the block 320 as part of block 325.

As part of block 320, at each iteration, in conventional SVGD, prior probabilities are combined with the likelihoods of each particle to form the target density and its gradient is weighted by a kernel function to provide the update directions for each particle. The gradient provided by prior probabilities and likelihood (i.e., the algorithm component) is determined at block 326. This process is then repeated until it arrives at a final set of particles that closely approximates the posterior distribution. The likelihood is determined assuming a statistical model of the seismic noise. In an embodiment, the gradient determined at block 326 is combined based on the requirement of matching the input LFM to form gradient scores evaluated at each particle, where the gradient scores are then scaled by a kernel function to update all the particles simultaneously in each iteration. After a predetermined number of iterations and/or when a pre-determined convergence criterion is met, a final set of particles that represents the target (posterior) distribution is generated. As discussed below, blocks 322, 324, and 330 can be processes undertaken as part of block 320.

Block 322 of block 320 includes evaluation of the kernel function that is used to scale the above described gradient scores. At block 324, the gradient for particle update is determined. Particularly, the gradient 324 includes both a probabilistic algorithm (e.g., a Bayesian probabilistic inference algorithm such as SVGD) component determined at block 326 (which includes the likelihood gradient and prior gradient) and an LFM component determined at block 328. In this exemplary method 300, the probabilistic algorithm component determined at block 326 represents the gradient applied in conventional SVGD techniques and generally represents the direction in which the current approximation of the probability distribution should be adjusted to better match the true distribution, and may be determined from a score matrix or function that measures the sensitivity of the current subsurface model's log-density to small perturbations.

The LFM component determined at block 328 is an additional component to the gradient determined at block 324 and is unique or different from the probabilistic algorithm component determined at block 326. Particularly, the LFM component determined at block 328 represents the direction the current approximation of the probability distribution should be adjusted to match the input LFM (e.g., the LFM generated at block 302) which thereby acts as an additional constraint on block 320. In other words, the LFM component determined at block 328 is derived from the requirement of matching the LFM (e.g., the LFM at block 302). In this exemplary embodiment, the probabilistic algorithm component determined at block 326 and the LFM component determined at block 328 are combined to form or define the gradient determined at block 324. Furthermore, the LFM component may be obtained by applying a low pass filter (e.g., having a frequency range matching the frequency range of the LFM) to the current particles to obtain a set of low frequency version of current particles, and calculating the LFM component determined at block 328 by subtracting the set of low frequency version of current particles from the input LFM.

The gradient determined at block 324 comprising both probabilistic algorithm component determined at block 326 and the LFM component determined at block 328 is used to form gradient scores evaluated at each particle, where the gradient scores are then scaled by the kernel function from block 322. The kernel function is a mathematical measure of similarity between the particles, but in the context of the algorithm it enforces diversity in the posterior. The determined gradient of block 324 is then used to update all the particles simultaneously in each iteration at block 330.

At block 332, a determination on whether convergence has occurred is undertaken. This determination may include a predetermined number of iterations of the above described process being undertaken and/or determination of whether a pre-determined convergence criterion is met. If the determination is negative with respect to the convergence at block 332, block 314 is undertaken with the revised values for the particles. If instead, at block 332, convergence is determined to have occurred, the final set of particles that represents the target (posterior) distribution is generated at block 334. It should also be noted that the output generated at block 334 can, in some embodiments, operate as an additional input to additional lithology and fluid predictions.

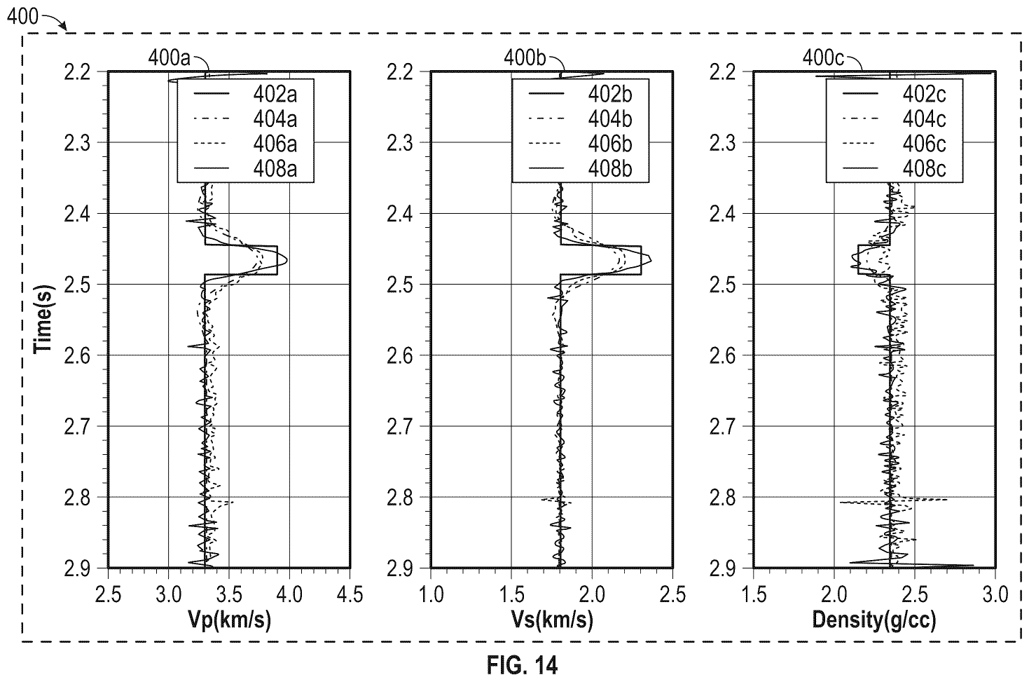

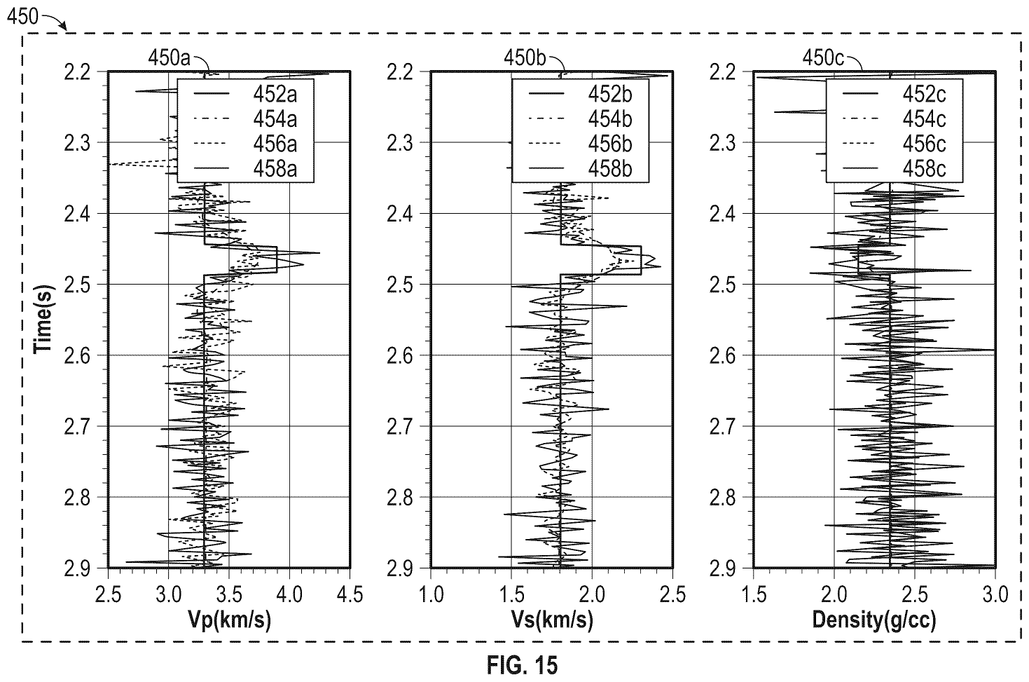

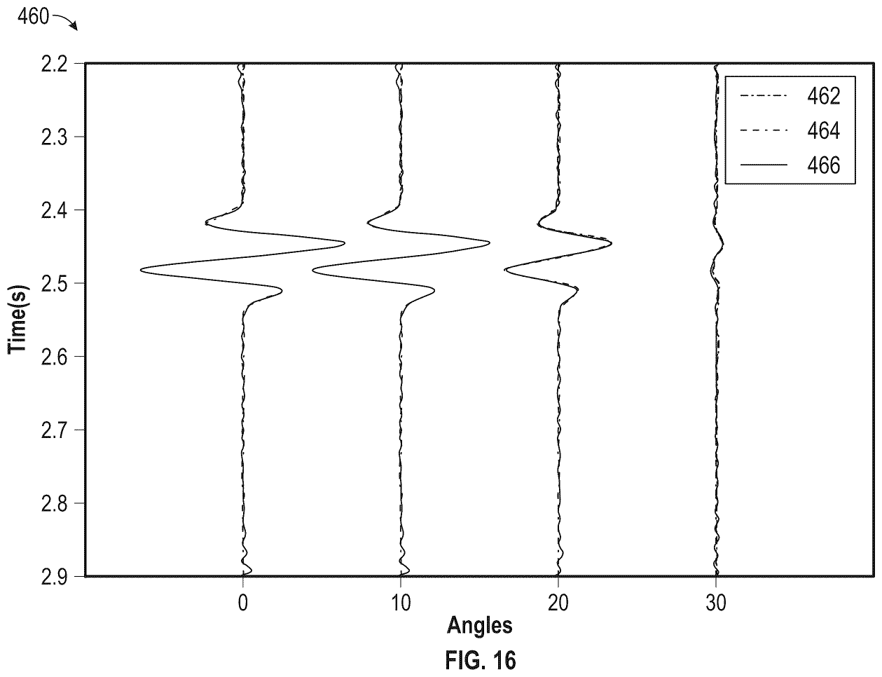

To further illustrate examples of the inverted elastic parameters generated using method 300, and referring to FIGS. 14-16, graphical representations illustrating a comparison of different subsurface model data with the actual model data (i.e., target subsurface model) are shown. Particularly, FIGS. 14-15 illustrate graphs overlaying elastic parameters of target model data representing a subsurface region along with elastic parameters of different modeled subsurface models. In addition, FIG. 16 illustrates a graph 460 of an overlay of input observed seismic data along with modeled seismic data based on models constrained to match both the observed seismic data and the LFM (i.e., using method 300). In this example, the subsurface models of FIGS. 14-16 are obtained using a probabilistic approach to seismic inversion (e.g., elastic stochastic seismic inversion).

FIG. 14 particularly illustrates a graph 400 of the mean of an exemplary posterior distribution of elastic parameters (p-wave velocity (Vp) 400a, s-wave velocity (Vs) 400b, and density 400c) of an exemplary subsurface model. Particularly, graph 400 plots the mean of the posterior distribution of the elastic parameters of the subsurface model as a function of time (y-axis) and speed in kilometers/second (km/s) (for elastic parameters Vp 400a and Vs 400b) and density in grams per cubic centimeter (g/cc) (for density 400c) along the x-axis. Elastic parameters 404a-404c represent the corresponding elastic parameters of the LFM input data, while elastic parameters 406a-406c represent the elastic parameters of an exemplary subsurface model constrained to match the observed seismic data only (not constrained to match the LFM i.e., using method 300 without block 328). Further, elastic parameters 408a-408c represent elastic parameters of an exemplary subsurface model constrained to match both the LFM and the observed seismic data (i.e., using method 300 with block 328). Finally, elastic parameters 402a-402c represent the expected or target elastic parameters of the surface region. As can be observed in FIG. 14, the elastic parameters 408a-408c of plots 400a, 400b and 400c of graph 400 is substantially aligned with the elastic parameters 402a-402c of plots 400a, 400b and 400c of graph 400. Thus, the elastic parameters 408a-408c of the LFM-enforced stochastic seismic inversion provides a more accurate approximation of the subsurface region.

FIG. 15 particularly illustrates a graph 450 of an exemplary particle elastic parameter (p-wave velocity (Vp) 450a, s-wave velocity (Vs) 450b, and density 450c) of an exemplary subsurface model. Particularly, graph 450 plots a one particle elastic parameters of the subsurface model as a function of time (y-axis) and speed in kilometers/second (km/s) (for elastic parameters Vp 450a and Vs 450b) and density in grams per cubic centimeter (g/cc) (for density 450c) along the x-axis. Elastic parameters 454a-454c of FIG. 15 represent the elastic parameters of the LFM input data, while elastic parameters 456a-456c represent the elastic parameters of a subsurface model constrained to match the observed seismic data only (i.e., using method 300 without block 328). In addition, elastic parameters 458a-458c represent the elastic parameters of the subsurface model constrained to match both the LFM and the observed seismic data (i.e., using method 300 with block 328). Further, elastic parameters 452a-45c of FIG. 15 represent exemplary target elastic parameters of the subsurface region. As can be observed in FIG. 15, the elastic parameters 458a-458c of plots 450a and 450b of graph 450 provide the closet approximation to the elastic parameters 452a-452c (i.e., elastic parameters of the target subsurface model) of plots 450a and 450b of graph 450. Thus, the elastic parameters of the LFM-enforced stochastic seismic inversion provides a more accurate representation of the subsurface region.

FIG. 16 particularly illustrates a graph 460 plotting input observed data 462 and synthetic seismic data 464 and 466 produced from an exemplary subsurface model as a function of time (y-axis) and offset angle (x-axis). In this example, synthetic seismic data 464 is produced from an exemplary subsurface model constrained to match the observed seismic data, while synthetic seismic data 466 represents synthetic seismic data produced from an exemplary subsurface model constrained to match both the observed seismic data and the LFM data (i.e., synthetic seismic data generated using the stochastic seismic data inversion discussed above with respect to FIG. 13). As can be observed in FIG. 16, all three models are substantially aligned.

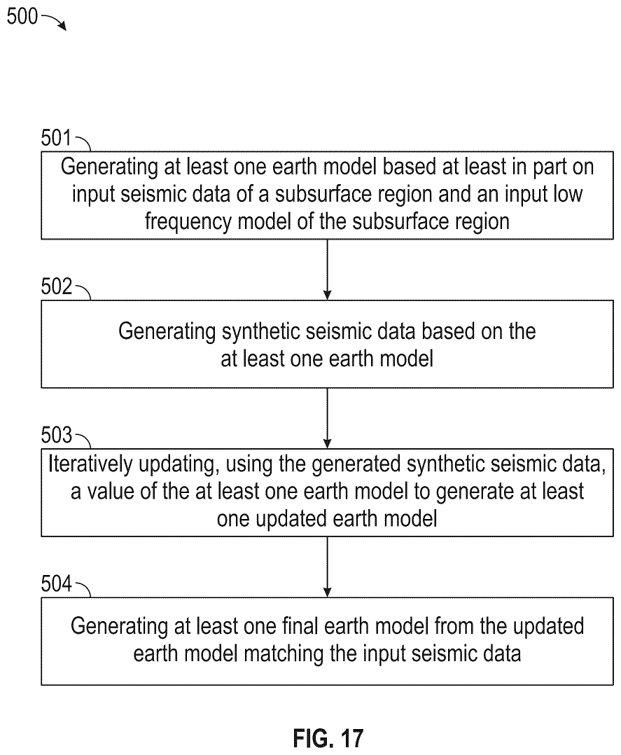

Referring now to FIG. 17, an embodiment of a method 500 for stochastic seismic data inversion in accordance with principles disclosed herein, is shown. At least some, if not all, of the steps or “blocks” of method 500 shown in FIG. 17 may be executed by the computing system 60 shown in FIG. 4, although it is to be understood that at least some of the steps of method 500 may be executed by systems other than computer system 60.

Beginning at block 501, method 500 includes generating at least one earth model based at least in part on input seismic data of a subsurface region and an input low frequency model of the subsurface region. In an embodiment the input data may include the low frequency model of Vp, Vs and density and seismic gather. As described above, the input low frequency model (i.e., LFM) may be built from any seismic imaging technique such as tomography or Full-Waveform inversion (FWI). The input data may also include other well log, geological and petrophysical data.

Method 500 continues at block 502 with generating synthetic seismic data based on the at least one earth model. The synthetic seismic data are generated by forward modeling of the initial particles (i.e., different combinations of Vp, Vs, and density), and includes solving the full Zoeppritz equation to obtain the desired synthetic seismic data.

At block 503, method 500 continues with iteratively updating, using the generated synthetic seismic data, a value of the at least one earth model to generate at least one updated earth model. Iteratively updating the at least one earth model comprises applying a low pass filter to the at least one earth model to generate a low pass filtered version of the at least one earth model, and comparing the low pass filtered version of the at least one earth model to the input low frequency model to shift the updated earth model towards the input low frequency model. As described above, at each iteration, gradient from the LFM, the prior probabilities, and the likelihood of each particle are combined to form the total gradient which is weighted by a kernel function to provide the update directions for each particle. As previously discussed, the LFM gradient component may be calculated by first applying a low pass filter to the current particles, then subtracting filtered results from the input LFM. Block 503 may be repeated until the model arrives at, at least one particle that closely approximates the posterior distribution.

Method 500 continues at block 504 with generating at least one final earth model from the updated earth model matching the input seismic data and honoring the input low frequency model. In this manner, the low pass filtered version of the at least one earth model matches the input low frequency model. The final set of particles generated by method 500 of FIG. 17 may be used to estimate subsurface elastic parameters (p-wave and s-wave velocities, and density) from processed seismic data (angle gathers or stacks). The resulting probabilistic volumes (e.g., 3D volumes) can be used, for example, in direct geological interpretation, deriving de-noised seismic data, such as reflectivity and elastic impedance volumes, computing elastic moduli and inferring other petrophysical properties, such as fluid and lithology types, or in other desired manners.

The systems and methods presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

What is claimed is:

1. A method comprising:
generating at least one earth model based at least in part on input seismic data of a subsurface region and an input low frequency model of the subsurface region;
generating synthetic seismic data based on the at least one earth model;
iteratively updating, using the generated synthetic seismic data, a value of the at least one earth model to generate at least one updated earth model, wherein iteratively updating the at least one earth model comprises applying a low pass filter to the at least one earth model to generate a low pass filtered version of the at least one earth model, and comparing the low pass filtered version of the at least one earth model to the input low frequency model such that a low pass filtered version of the updated earth model is iteratively shifted towards the input low frequency model; and
generating at least one final earth model from the updated earth model matching the input seismic data, wherein a low pass filtered version of the at least one final earth model matches the input low frequency model.

2. The method of claim 1, wherein generating the at least one earth model comprises generating a value for the at least one earth model based on at least one of geological, petrophysical, and seismic data.

3. The method of claim 1, further comprising forward modeling the at least one earth model to generate the synthetic seismic data.

4. The method of claim 3, wherein forward modeling the at least one earth model comprises solving Zoeppritz equation using the at least one earth model to generate the synthetic seismic data.

5. The method of claim 1, comprising utilizing a probabilistic algorithm during iteratively updating the value of the at least one earth model utilizing the synthetic seismic data, observed seismic data, and the input low frequency model.

6. The method of claim 5, comprising forming a gradient score as the value of the at least one earth model as part of the probabilistic algorithm and the input low frequency model.

7. The method of claim 6, wherein the gradient score comprises both a probabilistic algorithm component and a separate low frequency model component.

8. The method of claim 7, further comprising determining the low frequency model component of the gradient score based on the low pass filtered version of the at least one earth model.

9. The method of claim 8, wherein a frequency range of the low pass filter matches a frequency range of the input low frequency model.

10. The method of claim 1, wherein iteratively updating the value of the at least one earth model comprises matching the low pass filtered version of the at least one earth model to the input low frequency model.

11. The method of claim 1, wherein the at least one earth model corresponds to at least one subsurface elastic parameter.

12. The method of claim 1, further comprising producing the at least one final earth model as a target distribution.

13. A system comprising:
a one or more processors; and
a storage device coupled to the one or more processors, the storage device configured to store instructions that, when executed by the one or more processors, configure the one or more processors to:
generate at least one earth model based at least in part on input seismic data of a subsurface region and an input low frequency model of the subsurface region;
generate synthetic seismic data based on the at least one earth model;
iteratively update, using the generated synthetic seismic data, a value of the at least one earth model to generate at least one updated earth model, wherein iteratively updating the at least one earth model comprises applying a low pass filter to the at least one earth model to generate a low pass filtered version of the at least one earth model, and comparing the low pass filtered version of the at least one earth model to the input low frequency model such that a low pass filtered version of the updated earth model is iteratively shifted towards the input low frequency model; and
generate at least one final earth model from the updated earth model matching the input seismic data, wherein a low pass filtered version of the at least one final earth model matches the input low frequency model.

14. The system of claim 13, wherein the instructions, when executed by the one or more processors, configure the one or more processors to:
generate a value for the at least one earth model based on at least one of geological, petrophysical, and seismic data.

15. The system of claim 13, wherein the instructions, when executed by the one or more processors, configure the one or more processors to:
forward model the at least one earth model to generate the synthetic seismic data.

16. The system of claim 13, wherein the instructions, when executed by the one or more processors, configure the one or more processors to:
solve Zoeppritz equation using the at least one earth model to generate the synthetic seismic data.

17. The system of claim 13, wherein the instructions, when executed by the one or more processors, configure the one or more processors to:
utilize a probabilistic algorithm during iteratively updating the value of the at least one earth model utilizing the synthetic seismic data, observed seismic data, and the input low frequency model.

18. The system of claim 17, wherein the instructions, when executed by the one or more processors, configure the one or more processors to:
form a gradient score as the value of the at least one earth model as part of the probabilistic algorithm and the input low frequency model.

19. The system of claim 18, wherein the gradient score comprises both a probabilistic algorithm component and a separate low frequency model component.

20. The system of claim 19, wherein the instructions, when executed by the one or more processors, configure the one or more processors to:
determine the low frequency model component of the gradient score based on the low pass filtered version of the at least one earth model.
